(19) United States
(12) Patent Application Publication
(10) Pub. No.: US 2024/0208355 A1
(43) Pub. Date: Jun. 27, 2024

(54) INFORMATION PROCESSING METHOD

(71) Applicant: TOYOTA JIDOSHA KABUSHIKI KAISHA, Toyota-shi (JP)

(72) Inventors: Koji UEDA, Hunabashi-shi (JP); Ai Miyata, Osaka (JP); Hiroki Takeishi, Tokyo (JP); Koki Moriya, Nagakute-shi (JP); Ibuki Shimada, Miyoshi-shi (JP)

(73) Assignee: TOYOTA JIDOSHA KABUSHIKI KAISHA, Toyota-shi (JP)

(21) Appl. No.: 18/495,196

(22) Filed: Oct. 26, 2023

(30) Foreign Application Priority Data
Dec. 21, 2022 (JP) 2022-204715

(51) Int. Cl. B60L 53/64; B60L 53/57; B60L 58/16; G06Q 30/0226; G06Q 50/06

(52) U.S. Cl. CPC B60L 53/64; B60L 53/57; B60L 58/16; G06Q 30/0226; G06Q 50/06

(57) ABSTRACT

An information processing method by an information processing device includes: collecting vehicle data of a power supply destination vehicle and evaluating a state of a battery of the power supply destination vehicle; calculating, from an evaluation result, at least one of a period and a cost necessary for charging the battery; determining a power supply source vehicle that supplies power to the power supply destination vehicle; and providing an incentive to a user of the power supply destination vehicle when determining that a charging method by the user of the power supply destination vehicle is a charging method that reduces deterioration of the battery of the power supply source vehicle.

### CROSS-REFERENCE TO RELATED APPLICATION

This application claims priority to Japanese Patent Application No. 2022-204715 filed on Dec. 21, 2022, incorporated herein by reference in its entirety.

### BACKGROUND

### 1. Technical Field

The present disclosure relates to an information processing method.

### 2. Description of Related Art

Conventionally, a service is known in which a power supply vehicle rushes to a host vehicle and supplies power to the host vehicle, when a power supply request to the host vehicle is made on an application, (see, for example, NIO LIMITED, “NIO Power”, [online], 2022, [Searched on Dec. 14, 2022], Internet <URL:https://www.nio.com/nio-power>).

### SUMMARY

In the above-described background art, power supply that is good for the battery of the power supply source vehicle may not be performed.

In view of such circumstances, an object of the present disclosure is to prompt power supply that is good for the battery of the power supply source to be performed.

An information processing method according to an embodiment of the present disclosure is an information processing method with an information processing device. The information processing method includes: collecting vehicle data of a power supply target vehicle to evaluate a state of a battery of the power supply target vehicle; calculating, from an evaluation result, at least one of a period and cost needed for charging the battery; determining a power supply source vehicle that supplies power to the power supply target vehicle; and when determination is made that a charging method by a user of the power supply target vehicle is a charging method that reduces deterioration of a battery of the power supply source vehicle, giving an incentive to the user of the power supply target vehicle.

According to an embodiment of the present disclosure, it is possible to prompt power supply that is good for the battery of the power supply source vehicle to be performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram illustrating a configuration of an information processing device;

FIG. 3A is a block diagram illustrating a configuration of a user terminal and a worker terminal, respectively;

FIG. 3B is a block diagram illustrating a configuration of a user terminal and a worker terminal, respectively;

FIG. 4 is a diagram showing the structure of a vehicle DB (database);

FIG. 5 is a diagram illustrating an exemplary window presented to a user terminal; and

FIG. 6 is a flowchart illustrating an operation of the information processing device.

### DETAILED DESCRIPTION OF EMBODIMENTS

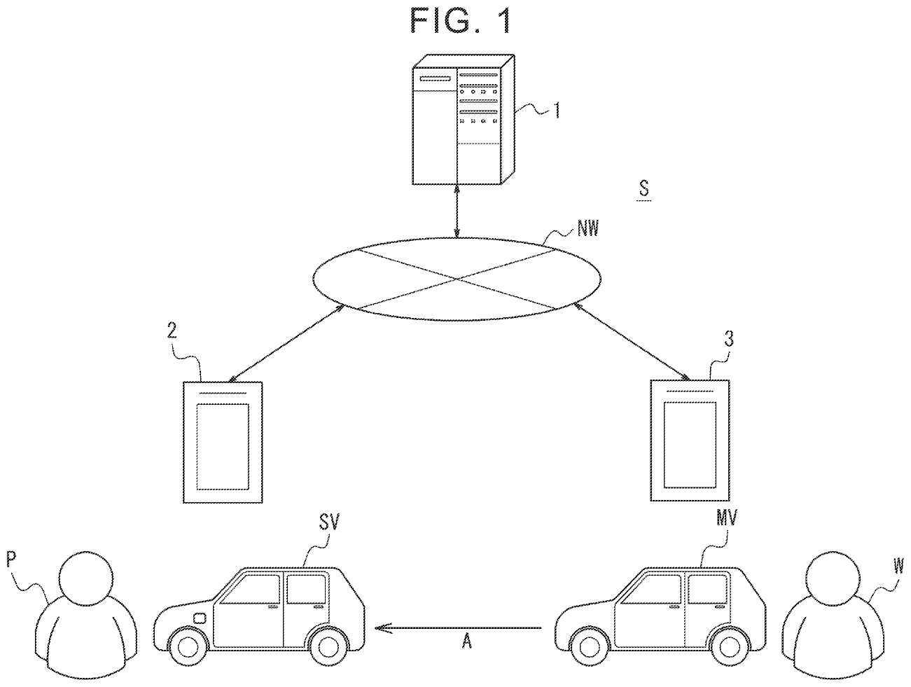

FIG. 1 is a schematic diagram of an information processing system S according to the present embodiment. The information processing system S includes an information processing device 1, a user terminal 2, and a worker terminal 3 that can communicate with each other via a network NW. The network NW includes, for example, a mobile communication network, a fixed communication network, or the Internet.

User terminal 2 is operated by user P. The user P drives the power supply target vehicle SV or rides on the power supply target vehicle SV. The worker terminal 3 is operated by the worker W. The worker W operates the power supply source vehicle MV or rides on the power supply source vehicle MV. The power supply source vehicle MV moves to the position of the power supply target vehicle SV in the direction A in response to a power supply request from the user P. This movement is referred to as, for example, running. The power supply source vehicle MV supplies power from the power supply source vehicle MV to the power supply target vehicle SV.

In FIG. 1, the information processing device 1, the user terminal 2, and the worker terminal 3 are illustrated one by one for convenience of explanation. However, the number of the information processing device 1, the user terminal 2, and the worker terminal 3 is not limited to this. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

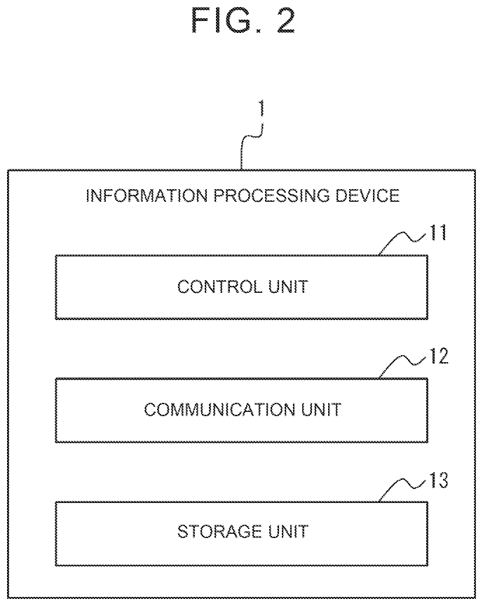

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including Central Processing Unit (CPU) or Micro Processing Unit (MPU). The control unit 11 may include one or more dedicated processors specialized for a specific process. The control unit 11 may include one or more dedicated circuits instead of including the processor. The dedicated circuitry may be, for example, Field-Programmable Gate Array (FPGA) or Application Specific Integrated Circuit (ASIC). The control unit 11 may include an Electronic Control Unit (ECU). The control unit 11 transmits and receives information via the communication unit 12.

The communication unit 12 includes a communication module corresponding to one or more wired or wireless Local Area Network (LAN) standards for connecting to a network NW. The communication unit 12 may include modules corresponding to one or more mobile communication standards including Long Term Evolution (LTE), 4th Generation (4G), or 5th Generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1. The storage unit 13 includes a vehicle DB.

The user terminal 2 is, for example, a mobile terminal such as a mobile phone, a smartphone, a wearable device, or a tablet. Alternatively, the user terminal 2 may be a general-purpose device such as a PC or a dedicated device. PC is an abbreviation for personal computer. User terminal 2 is operated by user P.

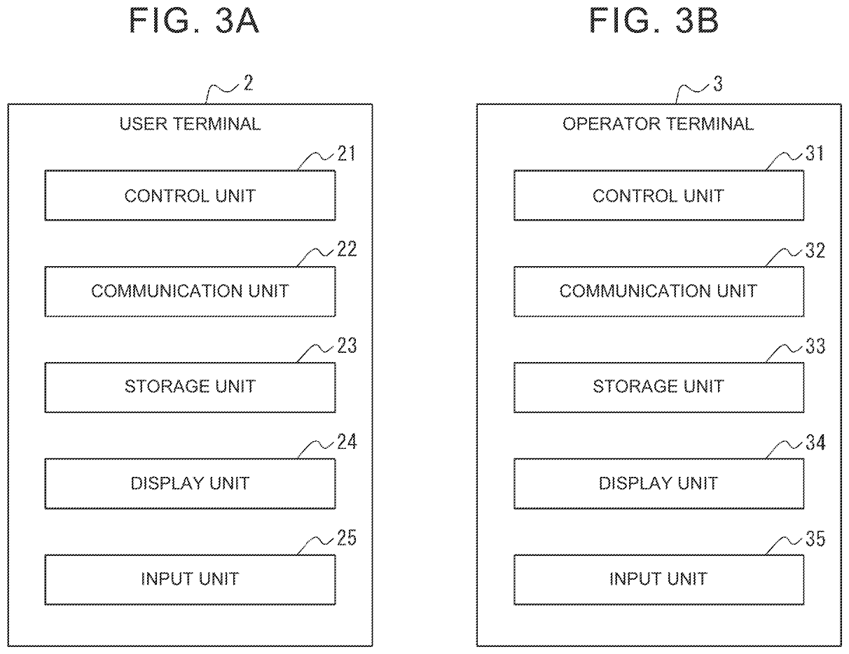

In FIG. 3A, the inner configuration of the user terminal 2 will be described.

The user terminal 2 includes a control unit 21, a communication unit 22, a storage unit 23, a display unit 24, and an input unit 25. Each component of the user terminal 2 is communicably connected to each other via, for example, a dedicated line.

The hardware configuration of the control unit 21, the communication unit 22, and the storage unit 23 of the user terminal 2 may be the same as the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. EL is an abbreviation for electro luminescence. Instead of being provided in the user terminal 2, the display unit 24 may be connected to the user terminal 2 as an external output device. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrally provided with a display, or a microphone. The input unit 25 receives an operation of inputting information used for the operation of the user terminal 2. Instead of being provided in the user terminal 2, the input unit 25 may be connected to the user terminal 2 as an external input device. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

In FIG. 3B, the inner configuration of the worker terminal 3 will be described. The worker terminal 3 includes a control unit 31, a communication unit 32, a storage unit 33, a display unit 34, and an input unit 35. The constituent elements of the worker terminal 3 are communicably connected to each other via, for example, a dedicated line.

The hardware configuration of the control unit 31, the communication unit 32, the storage unit 33, the display unit 34, and the input unit 35 of the worker terminal 3 may be the same as the hardware configuration of the control unit 21, the communication unit 22, the storage unit 23, the display unit 24, and the input unit 25 of the user terminal 2. The description here is omitted.

Hereinafter, an information processing method by the information processing system S will be described in detail. Here, a scene in which the user P requests the power supply to the power supply target vehicle SV will be described. Here, SV of the power supply target vehicles is a battery electric vehicle including a battery, but is not limited thereto.

The user terminal 2 transmits a power supply request to the power supply target vehicle SV to the information processing device 1.

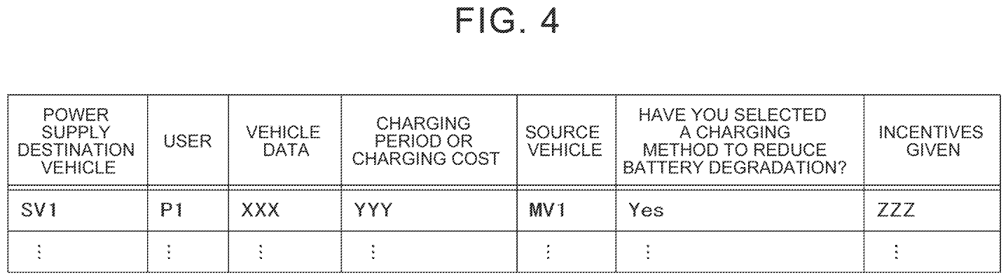

The control unit 11 of the information processing device 1 collects vehicle data of the power supply target vehicle SV. The vehicle data includes any data relating to the vehicle. Vehicle data is collected from a power supply target vehicle SV or other storage device. As illustrated in FIG. 4, the control unit 11 stores vehicle data in association with the power supply target vehicle SV.

The control unit 11 evaluates the state of the battery of the power supply target vehicle SV from the vehicle data. The state of the battery may be, for example, a remaining amount of the battery or a deteriorated state of the battery.

The control unit 11 calculates at least one of a duration and a cost required for charging the battery of the power supply target vehicle SV. The calculation method is arbitrary. As illustrated in FIG. 4, the control unit 11 stores the charging duration or the charging cost in association with the power supply target vehicle SV.

The control unit 11 determines a power supply source vehicle MV for supplying power to the power supply target vehicle SV. The power supply source vehicle MV may be determined in any manner from one or more vehicles. In the storage unit 13, the control unit 11 stores the power supply source vehicle MV in association with the power supply target vehicle SV.

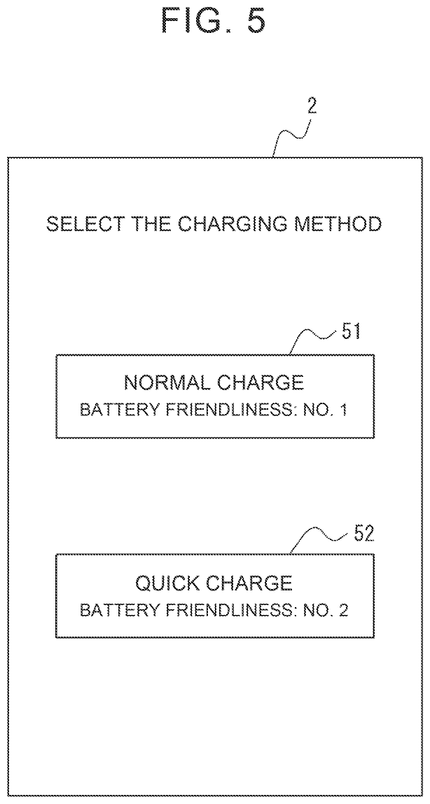

The control unit 11 determines whether the charging method by the user P of the power supply target vehicle SV is a charging method for reducing degradation of the battery of the power supply source vehicle MV. As illustrated in FIG. 5, for example, the control unit 11 presents a plurality of options of the charging method to the display unit 24 of the user terminal 2. The presentation may be performed, for example, when the power supply source vehicle MV runs to the position of the power supply target vehicle SV. Alternatively, a plurality of options may be presented at the indication of the power supply target vehicle SV or the power supply source vehicle MV. The options in FIG. 5 include a normal charge 51 and a quick charge 52. The normal charge 51 is a method for reducing deterioration of the battery. The quick charge 52 is a method that does not reduce degradation of the battery. That is, when the normal charge 51 is compared with the quick charge 52, the advantage of the normal charge 51 to the battery of the power supply source vehicle MV is one. The quick charge 52 has a second advantage over the battery. The control unit 11 determines whether or not the normal charge 51 has been selected by the user P. The control unit 11 stores the determination result in association with the power supply target vehicle SV.

When the control unit 11 determines that the charging method for reducing the degradation of the battery of the power supply source vehicle MV is selected, it incentivizes the user P of the power supply target vehicle SV. As illustrated in FIG. 4, for example, the control unit 11 stores the incentive in the storage unit 13 in association with the user P. Incentives include, for example, any of the following:
Discount on electricity
Discount on rental cars
Discount on lease expenses
Point

The incentive may be provided, for example, when a charging method that reduces battery degradation is selected or when charging is complete.

As an additional example or alternative, the control unit 11 may determine one or more candidates of the user P based on the position information of the one or more power supply target vehicle SV, and may incentivize the user P who participates in the charging among the determined one or more users P. The method of application is as described above.

As an additional example, the control unit 11 may give an incentive to the second user who has participated in charging after the user P. As an additional example, the control unit 11 may give an incentive to the user P who has changed the charging reservation (for example, the charging period, the charging start time, the charging end time, the charging amount, and the like) in accordance with the second user who has participated in the charging later. For example, in the following case, the control unit 11 may give an incentive to the user P.
In order to charge the 2 power supply target vehicle operated by the 2 user, the user P changes the charge reservation so as not to fully charge the power supply target vehicle SV
When the user P changes the charging reservation so that the charging start time of the 2 power supply target vehicle operated by the 2 user matches the charging end time of the power supply target vehicle SV When determining that the second power supply target vehicle has arrived for charging at a position where the power supply target vehicle SV is present (for example, a position where the power supply target vehicle SV is charging), the control unit 11 may give an incentive to the second user.

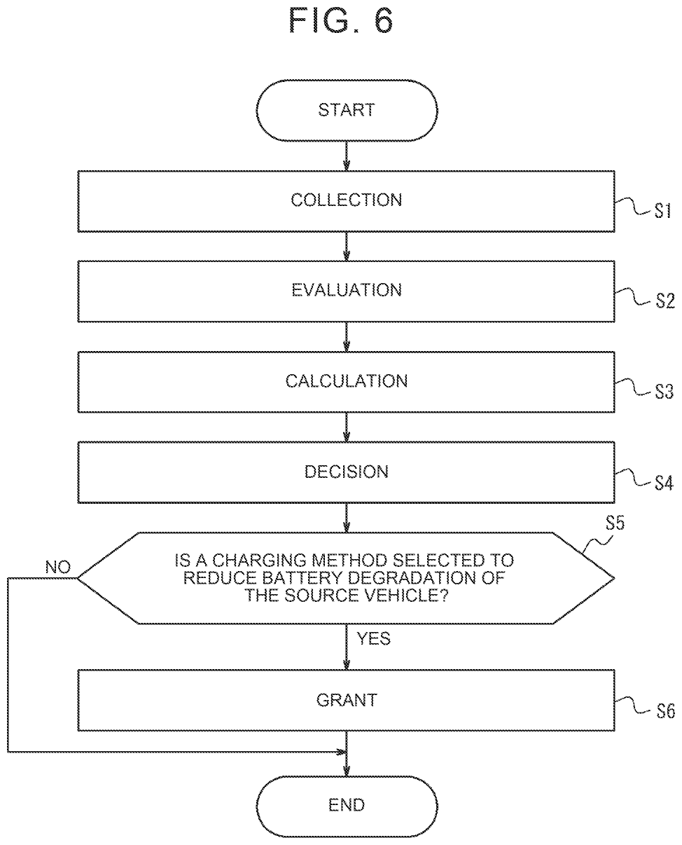

In FIG. 6, an information processing method by the control unit 11 of the information processing device 1 will be described. The process illustrated in FIG. 6 may be executed, for example, when a power supply is requested from the user P of the power supply target vehicle SV.

In S1, the control unit 11 collects vehicle data of the power supply target vehicle SV. In S2, the control unit 11 evaluates the condition of the battery of the power supply target vehicle SV.

In S3, the control unit 11 calculates at least one of a duration and a cost required to charge the battery. In S4, the control unit 11 determines a power supply source vehicle MV for supplying power to the power supply target vehicle SV.

In S5, the control unit 11 determines whether or not the charging method selected by the user P of the power supply target vehicle SV is a charging method for reducing degradation of the battery of the power supply source vehicle MV. When S5 is No, the control unit 11 ends the process of FIG. 6. When S5 is Yes, the control unit 11 gives an incentive to the user P of the power supply target vehicle SV in S6.

As described above, according to the present embodiment, the operation of the control unit 11 of the information processing device 1 includes: collecting the vehicle data of the power supply target vehicle SV and evaluating the state of the battery of the power supply target vehicle SV; calculating, from the evaluation result, at least one of the period and the cost required for charging the battery; determining the power supply source vehicle MV for supplying power to the power supply target vehicle SV; and, when determining that the charging method by the user P of the power supply target vehicle SV is the charging method for reducing the degradation of the battery of the power supply source vehicle MV, providing an incentive to the user P of the power supply target vehicle SV. With this configuration, the information processing device 1 can prompt the power supply gentle to the battery of the power supply source vehicle MV.

Further, according to the present embodiment, the operation of the control unit 11 includes: presenting a plurality of options of the charging method to the user P and accepting a selection for one option; determining whether the charging method selected by the user P is a charging method for reducing the deterioration of the battery of the power supply source vehicle MV; and incentivizing the user P when determining that the selected charging method is a charging method for reducing the deterioration of the battery of the power supply source vehicle MV. Multiple options for charging methods include rapid charging and normal charge. The way to reduce the degradation of the battery of the power supply source vehicle MV is usually a charge. With this configuration, the information processing device 1 can prompt the user P to supply power gently to the battery of the power supply source vehicle MV while giving a plurality of options of the charging methods.

Further, according to the present embodiment, the incentive includes a discount on an electric charge, a discount on a rental car charge, a discount on a lease charge, or a point. With this configuration, the information processing device 1 can further urge the power supply gentle to the battery of the power supply source vehicle MV.

In addition, according to the present embodiment, the operation of the control unit 11 includes providing an incentive to the second user when it is determined that the second power supply target vehicle driven by the second user has arrived at the position of the power supply target vehicle SV. With this configuration, the control unit 11 of the information processing device 1 can increase the sales in one move of the power supply source vehicle MV.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above embodiment, a program that executes all or part of the functions or processes of the information processing device 1 can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a Digital Versatile Disc (DVD) or a Compact Disc Read Only Memory (CD-ROM) in which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method with an information processing device, the information processing method comprising:
collecting vehicle data of a power supply target vehicle to evaluate a state of a battery of the power supply target vehicle;
calculating, from an evaluation result, at least one of a period and cost needed for charging the battery;
determining a power supply source vehicle that supplies power to the power supply target vehicle; and
when determination is made that a charging method by a user of the power supply target vehicle is a charging method that reduces deterioration of a battery of the power supply source vehicle, giving an incentive to the user of the power supply target vehicle.

2. The information processing method according to claim 1, wherein the information processing method includes:
presenting a plurality of options for a charging method to the user to receive a selection for one option;
determining whether a charging method selected by the user is the charging method that reduces the deterioration of the battery of the power supply source vehicle; and
when determination is made that the selected charging method is the charging method that reduces the deterioration of the battery of the power supply source vehicle, giving the incentive to the user.

3. The information processing method according to claim 2, wherein:
the options for the charging method include quick charge and normal charge; and
the method that reduces the deterioration of the battery of the power supply source vehicle is the normal charge.

4. The information processing method according to claim 1, wherein the incentive includes a discount on an electricity bill, a discount on a rental car fee, a discount on a lease fee, or a point.

5. The information processing method according to claim 1, wherein the information processing method includes, when determination is made that a second power supply target vehicle driven by a second user has arrived at a location of the power supply target vehicle, giving the incentive to the second user.
